(19) United States
(12) Patent Application Publication
(10) Pub. No.: US 2012/0017141 A1
(43) Pub. Date: Jan. 19, 2012

(54) METHOD FOR CREATING INTERACTIVE POINTS

(75) Inventors: Vadim Vorobiev Eelen, Paris, OH (US); Nikita Vorobiev Eelen, Paris, OH (US)

(73) Assignee: AVE INTERVISION L.L.C., Alliance, OH (US)

(21) Appl. No.: 13/183,886

(22) Filed: Jul. 15, 2011

Related U.S. Application Data
(60) Provisional application No. 61/365,422, filed on Jul. 19, 2010.

(51) Int. Cl. G06F 17/00

(52) U.S. Cl. 715/202

(57) ABSTRACT

A method of creating interactive points to provide for an interactive educational content based on at least one of live and prerecorded digital multimedia content that includes recording an original source multimedia content to a server and receiving a separate source multimedia content by at least one third-party. An interactive point is created within the original source multimedia content and the interactive point includes a reference to a uniform resource locator stored in the server and is linked to the separate source multimedia content. When the interactive point is selected, the original source multimedia content is altered to include the separate source multimedia content which is transmitted to the user device. An indication is received from the user device corresponding to the user interaction and a response is determined based upon the received indication.

### CROSS-REFERENCE TO RELATED APPLICATION

This application claims the benefit of U.S. Provisional Application No. 61/365,422, which was filed on Jul. 19, 2010.

### BACKGROUND OF THE INVENTION

1. Field of the Invention

The invention relates to the art of the creation of multimedia content. More particularly, the invention is directed to a method for the creation of interactive multimedia content that includes the creation of interactive points in the interactive, multimedia content that enable control of the flow of the receipt of information.

2. Background Art

The ability to create, store, and display digital interactive multimedia content is extremely useful in communicating information to others. For example, in the educational environment, learning is increasingly taking place on computers and on computer-related devices, such as handheld digital units. In order to enhance the learning experience for a user, information is often presented as multimedia content, which involves the display of graphics, pictures, text, sounds, and other multimedia and static digital information. Often, in order to provide the best possible educational materials, such multimedia content combines information from multiple sources into a single informational display. In addition, the multimedia content is often interactive, that is, information is displayed as desired by the user who is learning the information, or is displayed on an incremental basis, which may increase the enhancement of the learning, experience.

It is known in the prior art that the ability to create, store, and display digital interactive multimedia content has been limited. More particularly, prior art systems permitting the storage and display of digital interactive multimedia content typically only support interaction with one original source of digital interactive multimedia content. This interaction with one source of content applies to systems that are client-based, in which the content is stored on the user's computer, or server-based, in which the content is stored on a server, and the server may be Internet-based or local to the user.

For example, in the prior art, in an interactive video presentation or a slide show presentation, digital links to certain information or content may be inserted into the presentation. However, in the prior art, when a user views the presentation, those links must be activated manually, which may be difficult and/or undesirable for the user. Such activation may include difficult and/or undesirable manual starting, stopping, and/or pausing of the presentation by the user while interacting with the multimedia content. In addition, if a user desires to set the playback of certain content to begin at a different portion of the original interactive multimedia content than was originally designed, the prior art content is not able to perform such an adjustment.

This lack of control over digital interactive multimedia content may undesirably decrease the effectiveness of the interactive multimedia content in an educational environment. In addition, even in an entertainment environment, such a lack of control over digital interactive multimedia content may undesirably decrease the effectiveness of the interactive multimedia content.

As a result, there is a need in the art for a method for the creation of interactive multimedia content that includes the creation of interactive points in the multimedia content that enable control of the flow of the receipt of information. The method for creating interactive points of the present invention satisfies this need, as will be described in detail below.

### BRIEF SUMMARY OF THE INVENTION

An objective of the present invention is to provide a method for the creation of interactive multimedia content that allows multiple sources and users to create and contribute to an educational experience.

Another objective of the present invention is to provide a method for the creation of interactive multimedia content that includes the creation of interactive points that allow for various user interactions when the point is reached during the educational presentation.

Yet another objective of the present invention is to provide the creation of interactive points within a timeline of the interactive multimedia content that enables a user to interact with the interactive multimedia content.

These objective and others are obtained by the method for creating interactive points to provide an interactive educational content based on at least one of live and prerecorded digital multimedia content. In an exemplary embodiment of the invention, the method includes recording an original source interactive multimedia content to a server and receiving a separate source interactive multimedia content created by at least one third-party. At least one interactive point is created within the original source interactive multimedia content that includes a reference to a uniform resource locator stored in the server that links the interactive point to the separate source interactive multimedia content. The original source interactive multimedia content is altered to include the separate source interactive multimedia content when the interactive point is selected. The altered original source interactive multimedia content is transmitted to a user device for user interaction when the at least one selected interactive point is selected. An indication is received from the user device corresponding to the user interaction and a response is determined from the received indication where the response corresponds to at least one of continuing user interaction, assessing the received indication and switching to a new source interactive multimedia content.

These objectives and others are also obtained by a non-transitory computer-readable storage medium with an executable program stored thereon for providing an interactive multimedia content for a user to create or interact with interactive points corresponding to the interactive multimedia content. The program instructs a microprocessor to perform storing of the interactive multimedia content in an in multimedia content server database in which the interactive multimedia content comprises at least one of original source interactive multimedia content and a separate source interactive multimedia content created by a third-party. The at least one interactive point is stored in the multimedia content server database in association with the least one of the original source interactive multimedia content and the separate source interactive multimedia content in which the at least one of the interactive points is reached by a play head over a timeline. A response is determined based upon a predetermined frame number corresponding to the play head whether to at least one of alter the original source interactive multimedia content, to provide the user with a choice of switching to the separate source interactive multimedia content and to continue interacting with interactive multimedia content and the determined response is transmitted to a user device for interaction.

These objective and others are also obtained by a computer system for providing a creation and a mix of educational interactive multimedia content. In an exemplary embodiment of the invention, the computer system includes multimedia content based on different types of multimedia materials with automatic assessment. The computer system includes a server application with a database and an interactive point database storing an interactive multimedia content and an interactive point corresponding to at least one of original interactive multimedia content, separate source interactive multimedia content and a uniform resource locator. When the interactive point is reached, the computer system plays back the altered original interactive multimedia content by overlapping the original interactive multimedia content with a new source interactive multimedia content that opens in a separate window and at least one of opening on top of a browser, inside of a presentational window of the browser, and paused for the user to make a selection. The selection appears alone or with at least one of a button and selected object highlighted, and installed on top or inside of the original interactive multimedia content on a user device in a form of the button, image or selection with at least one of a key with text, picture, animation and any other visual art found in the presentational window of the browser. The at least one of the key and the visual art object is selected to send a request to the server application to request for the new source interactive multimedia content and display the new source interactive multimedia content on the user device for interaction with the new source interactive multimedia content in conjunction with a selection of the interactive point from the user device.

### BRIEF DESCRIPTION OF THE SEVERAL VIEWS OF THE DRAWINGS

The preferred embodiment of the present invention, illustrative of the best mode in which Applicants have contemplated applying the principles, is set forth in the following description and is shown in the drawings, and is particularly and distinctly pointed out and set forth in the appended claims.

FIG. 1 is a block diagram of an exemplary system architecture for allowing a user to manipulate interactive multimedia content, according to an exemplary embodiment of the method for creating interactive points of the present invention;

FIG. 2 is an exemplary display showing interactive point multimedia overlays that may be installed over any viewable or hidden part of the interactive multimedia content, according to the exemplary embodiment of the method for creating interactive points of the present invention;

FIG. 3 is an exemplary display similar to FIG. 2, showing an exemplary interactive point represented by uniform resource locator (“URL”) content or a URL address, which may appear over any part of the interactive multimedia content, according to the exemplary embodiment of the method for creating interactive points of the present invention;

FIG. 4 is an exemplary display similar to FIG. 2, showing an exemplary interactive point represented by computer-generated buttons, according to the exemplary embodiment of the method for creating interactive points of the present invention;

FIG. 5 is an exemplary display similar to FIG. 2, with the additional display of an editing suite, showing certain aspects of the creation of an exemplary interactive point for the multimedia content, according to the exemplary embodiment of the method for creating interactive points of the present invention; and

FIG. 6 is an exemplary display similar to FIG. 5, showing additional aspects of the creation of an exemplary interactive point for the multimedia content, according to the exemplary embodiment of the method for creating interactive points of the present invention.

Similar numerals refer to similar parts throughout the drawings.

### DESCRIPTION OF THE INVENTION

The method for creating interactive points of the present invention includes systems and methods for interaction, such as switching and mixing of original source interactive multimedia content with separate source interactive multimedia content via interactive points, which enables the creation of enhanced interactive multimedia educational content, or enhanced interactive multimedia entertainment content. It is to be understood that interactive multimedia content includes at least one of original source interactive multimedia, new source multimedia content and new source interactive multimedia content. It is also to be understood that the present invention applies to applications that are client-based, in which the multimedia content is stored on a user's device, aria to applications that are server-based, in which the multimedia content is stored on a server, and the server may be Internet-based or local to the user which includes a land area network (“LAN”). In addition, the interactive points may be designed and hosted online and/or offline.

In the method for creating interactive points of the present invention, the interactive multimedia content includes at least one of original source interactive multimedia content and separate source interactive content. Interactive multimedia content also includes one or more interactive points, which alters the flow and interaction of the educational process of the interactive multimedia content as the content was originally designed. By way of example, in the method for creating interactive points of the present invention, an electronic timeline for the display of the original interactive multimedia content is created, in one exemplary interactive point, once that timeline reaches a predetermined point, or frame, there is an automatic switch from the original interactive multimedia content into separate source interactive multimedia content. The separate source interactive multimedia content may reside on a separate location on a computer network, or on the computer of the end user or at a third-party location.

In another exemplary interactive point, once the timeline for the display of the original interactive multimedia content timeline reaches a predetermined point, or frame, computer-generated buttons that enable control over presentation are displayed on the user's computer or electronic device. The buttons may be displayed with or without text that explain options that are available to the user. For example, the buttons may enable the user to stop or alter the playing or playback of the original interactive multimedia content.

In yet another exemplary interactive point, once the timeline for the display of the original interactive multimedia content timeline teaches a predetermined point, or frame, an overlay that includes a URL address or URL content is displayed over any viewable part of the interactive multimedia content. The URL address preferably is electronically connected or linked to a certain frame of the original interactive multimedia content timeline, or to certain stand-alone multimedia content, in order to provide additional information to the user during the delivery of certain educational material. By providing a URL address or a link to additional materials, the interactive points may be used to link separate source interactive multimedia content for education or entertainment in which selecting specific interactive points will lead the user to a different source of information or to an assessment, thereby enhancing the communication of educational information and the educational experience.

In another exemplary interactive point, once the timeline for the display of the original interactive multimedia content timeline reaches a predetermined timeline range for the original interactive multimedia content, separate source interactive multimedia content and new source interactive content, the interactive multimedia content that is associated with the timeline range is displayed.

In another exemplary interactive point, once the timeline for the display of a first interactive multimedia content timeline reaches a predetermined timeline range for the first interactive multimedia content, separate source interactive multimedia content and new source interactive content, the interactive multimedia content that is associated with the first timeline range is displayed.

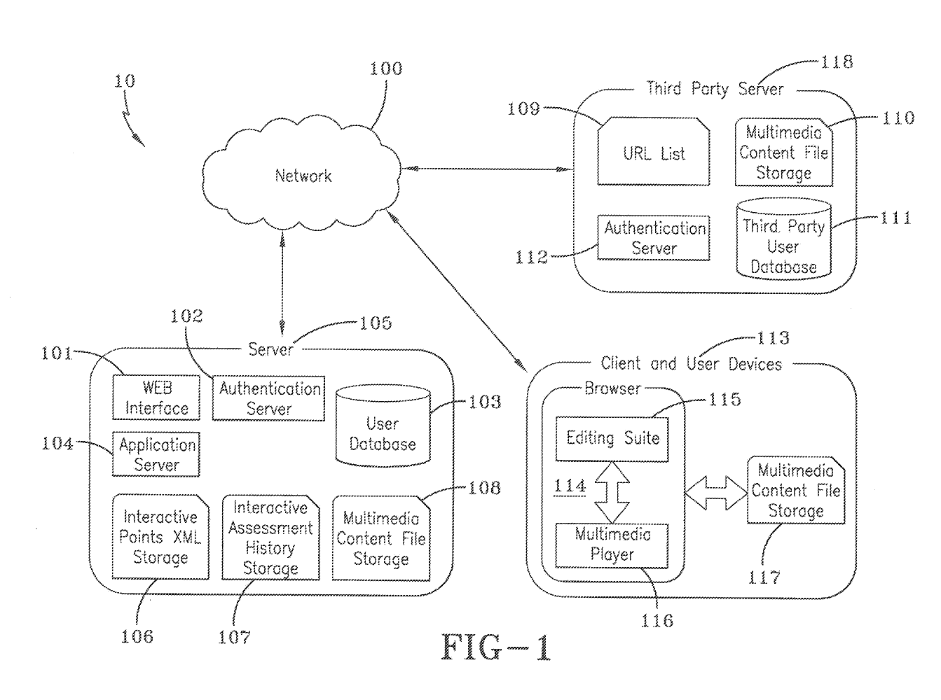

Turning now to FIG. 1, an exemplary embodiment of the method for creating interactive points of the present invention is indicated generally at 10, FIG. 1 shows an exemplary system architecture for allowing a user to manipulate interactive multimedia content, according to method for creating interactive points 10. The system architecture preferably includes a server 105, which in turn includes an Internet or web interface 101, an authentication server 102, an application server 104, storage means 106 for storing interactive points in a format such as Extensible Markup Language (“XML”), storage means 107 for storing an interactive assessment history, storage 108 for multimedia content files, and a user database 103.

Other usual features, such as a network interface, firewalls, routers, switches, load balancers, failover systems, site management tools, and so forth, preferably are included in the system architecture, as known to those skilled in the art, and are not shown so as to more clearly illustrate the principal features of the system.

Examples of an appropriate server 105 for implementation of method for creating interactive points 10 include servers that host certain web sites. Of course any server that hosts a web site may be suitable for use as server 105, and may be modified to work according the description provided herein. It is understood that the term “web site” represents any arrangement and/or technique of providing content, and is not partial to applications and/or infrastructures that support content which is created or/and delivered by using the Internet or the Hypertext Transfer Protocol (“HTTP”) or the User Datagram Protocol (“UDP”).

Server 105 is typically implemented, whether as a stand-alone component or as an arrangement of numerous software and/or hardware components, by electronic connection to a network 100. Communication between server 105 and network 100 generally is facilitated by web interface 101. It is to be understood that functions described as being presented on the server side can also be implemented on the client side, depending on the specific implementation of method of creating interactive points 10 and specific circumstances.

On the user side, client and user devices 113 interact with a browser 114 to connect to server 105 over network 100. Preferably, network 100 is the Internet. However, network 100 may be any network known to those skilled in the art, including but not limited to a local area network (“LAN”), metropolitan area network (“MAN”), wide area network (“WAN”), mobile network, wired network, wireless network, private network, or virtual private network. In addition, while only a single client and user device 113 and browser 114 are shown, it is understood that large numbers of clients and user devices 113 may be supported and may interact with server 105 at any time. Moreover, client and user devices 113 include all types or kinds of user devices known to those skilled in the art, such as, for example, desktop computers, laptop computers, I-Pods, mobile devices, smart phones, computer readable media and game consoles.

Preferably, browser 114 includes an editing suite 115 and multimedia player 116, which are operatively connected to one another. The interconnection of editing suite 115 and multimedia player 116 may be provided by a flash player or a HyperText Markup Language (“HTML”) player. Alternatively, playback may be facilitated over a Sharable Content Object Reference Model (“SCORM”) compliant player, which may be incorporated into a Content Management System (“CMS”) or a Learning Management System (“LMS”). Examples of such systems include Moodle, Blackboard, Sakai, Sakai, or other suitable player adapted for interactive multimedia, content file formats used in server 105.

Optionally, rather than connecting directly to server 105 over network 100, client and user devices 113 may connect to the server over the network using a third-party server 118. By way of example, third-party server 118 may include a URL list 109, storage means 110 for multimedia files, a third-party user database 111, and an authentication server 112.

Once connected to server 105, a user preferably accesses original source interactive multimedia content recorded on the server by browsing a list of recorded sessions that are located inside a multimedia content file storage area 117 on user device 113 and/or inside user database 103 on the server. Alternatively, the user may conduct searches of user database 103 and/or multimedia content file storage 108 on server 105 using keywords, may review separate source interactive multimedia content created by other users or a third-party, may review other separate source interactive multimedia content created by the system administrator in a content library, or may view additional separate source interactive multimedia content associated with specific libraries of interactive multimedia content, such as certain communities or units.

Client and user devices 113 may also receive separate source interactive multimedia content based on tagged interactive multimedia content, URL's, specific assessments, and ether application files. For a given topic or set of original source interactive multimedia content, server 105 generates this additional interactive multimedia content. For example, a group of possible answers associated with original source interactive multimedia content may be offered to the user by server 105. Based on the answer chosen by the user, server 105 delivers additional interactive multimedia content associated with that answer to the user. Such interactivity is achieved by client and user devices 113 making a request to user database 103 which, working together with interactive assessment history storage 107 and multimedia content file storage 108 as an in search engine, enables such specific responses to be provided to the user or group of users.

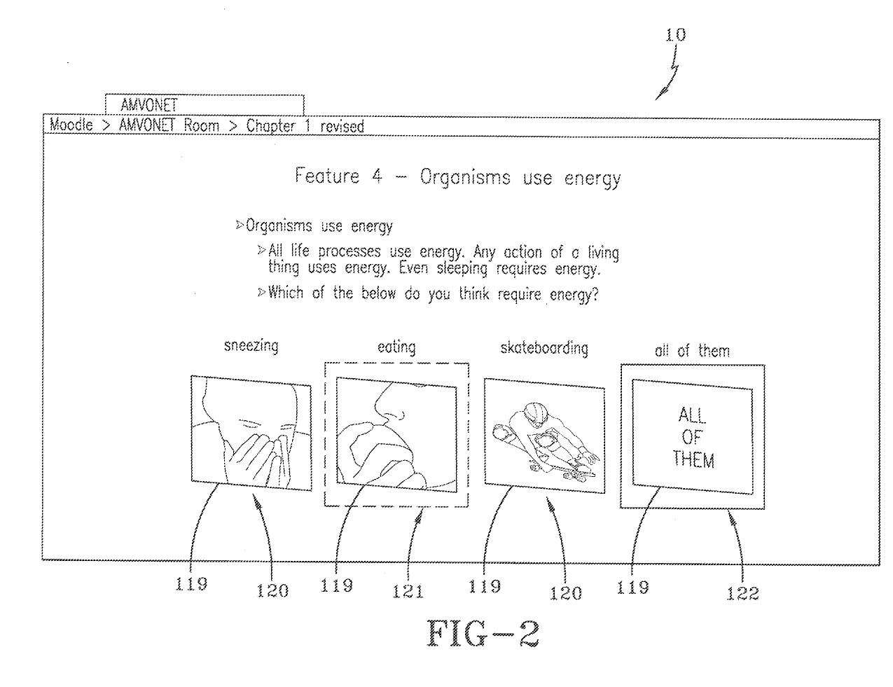

Turning now to FIG. 2, method for creating interactive points 10 of the present invention includes interactive point multimedia overlays that may be installed over any viewable or hidden part of the original source interactive multimedia content. More particularly, a display of user device 113 (FIG. 1) includes specific interactive multimedia content. Overlaid upon this content are interactive point multimedia overlays 119. It is to be understood that interactive point multimedia overlays 119 are not limited to those shown in FIG. 2, and may include a picture, animation, video, web-site, file, document, and the like, as well as combinations thereof. Preferably, interactive point multimedia overlays 119 include three types or stages: inactive 120; selected 121; and activated 122. More particularly, inactive overlays 120 are displayed, and have not been selected or activated. Selected overlays 121 have been selected, potentially for activation, but have not yet been activated. Activated overlays 122 have been activated for viewing or interaction.

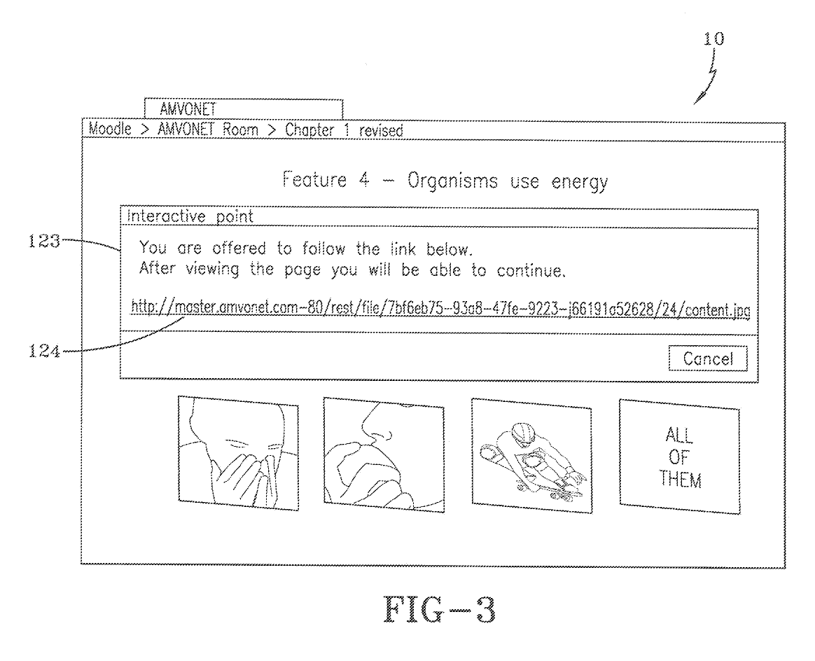

Referring now to FIG. 3, method for creating interactive points 10 of the present invention includes an exemplary interactive point represented by a URL box 123 or a URL address 124, which truly appear over any part of the interactive multimedia content that is display to the user via user device 113 (FIG. 1). When an overlay 119 (FIG. 2) is selected or activated, as configured based on specific requirements, URL box 123 and/or URL address 124 may be displayed for selected overlays 121 and/or activated overlays 122. Because the choice of selection 123 or activation 124 of overlays is already made through the use of application server 104 (FIG. 1), that action is predetermined on behalf of user devices 113. In this manner, a URL is displayed on top or inside of any given interactive multimedia content frame automatically, without the need for the user to click on any part of the interactive multimedia content. It is to be understood that URL box 123 is not limited to the choices shown in FIG. 3, and that the URL box may be displayed over any viewable or hidden part of the interactive multimedia content, including, but not limited to, pictures, animations, videos, web sites, file, documents, and the like.

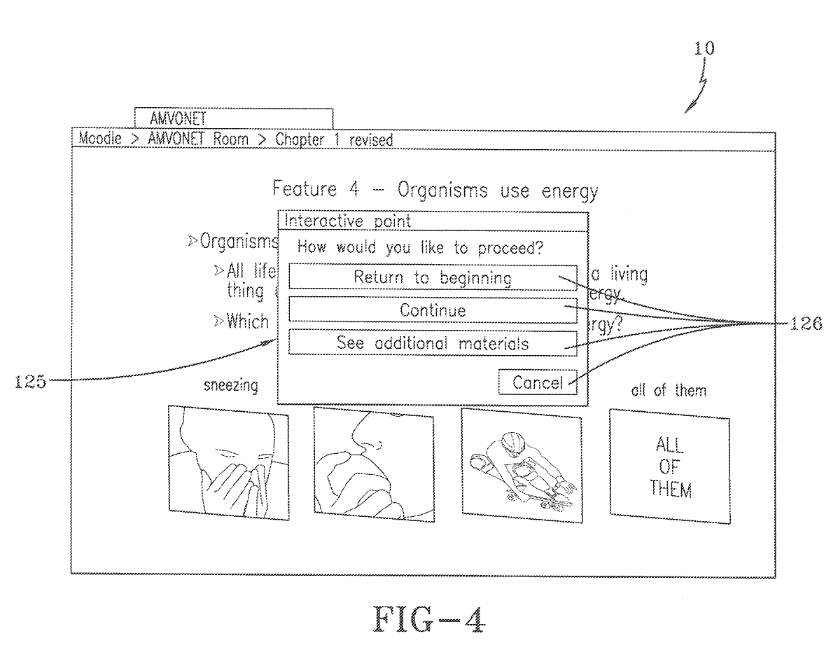

Turning now to FIG. 4, method for creating interactive points 10 of the present invention includes an exemplary interactive point represented by computer-generated buttons 125. Buttons 125 may be with or without text 126. As described above, in the method for creation interactive points 10, an electronic timeline for the display of the original source interactive multimedia content is created. Once that timeline reaches a predetermined point, or frame, buttons 125 are displayed on user device 113 (FIG. 1). Preferably, display of the predetermined frame is determined by a play head of an interactive multimedia content player, which may overlay and appear over any viewable part of the interactive multimedia content that is displayed on user device 113. It is to be understood that button 123 and text 126 are not limited to the specific choices shown in FIG. 4, and may also be displayed over any viewable or hidden part of the interactive multimedia content including, but not limited to, pictures, animations, videos, web sites, text chat, games, files, documents, and the like.

All of the above-described interactive points may optionally include user-generated customization of the visual presentation of the interactive points, such as customization of the colors and/or shapes of the display of the interactive points. In addition, all of the above-described interactive points may optionally include user-generated types or complexities of interconnectivity between the interactive points. For example, method for creating interactive points 10 of the present invention includes the capability to enable the user to manipulate or customize the amount of time that a certain interactive point is displayed, and/or the specific choices that are displayed for certain interactive points. If desired by the user, during interaction with any interactive point, the amount of time that user device 113 may observe a specific interactive point before the user decides to proceed with a certain choice of action may be unlimited.

By way of further example, the interactive point may include an interactive assessment in which a user clicks or selects an answer to a question that is presented in the multimedia content as shown in FIG. 2. If the user chooses an answer that is wrong, the original source interactive multimedia content automatically moves or jumps to a predetermined frame or portion of the interactive multimedia content that corresponds to that specific wrong answer and the particular subject matter related to the question. An interactive point is displayed for the user, directing the user to interactive multimedia content that contains an explanation as to why the selected answer is wrong, and also provides the user with a choice among a variety of different forms of separate source interactive multimedia content through which the user can learn by the user was wrong and receive an explanation of the correct answer to the given question or problem as shown in FIG. 3.

Alternative if the user chooses a correct answer, the interactive multimedia content automatically moves or jumps to a predetermined frame or portion of the interactive multimedia content that contains a display of congratulations for the user with an immediate confirmation that the choice made by the user is correct. In addition, based on the confirmation of the correct answer, the interactive multimedia content optionally provides the user with a choice to proceed further with the given educational material, or to exit that specific interactive multimedia content sequence.

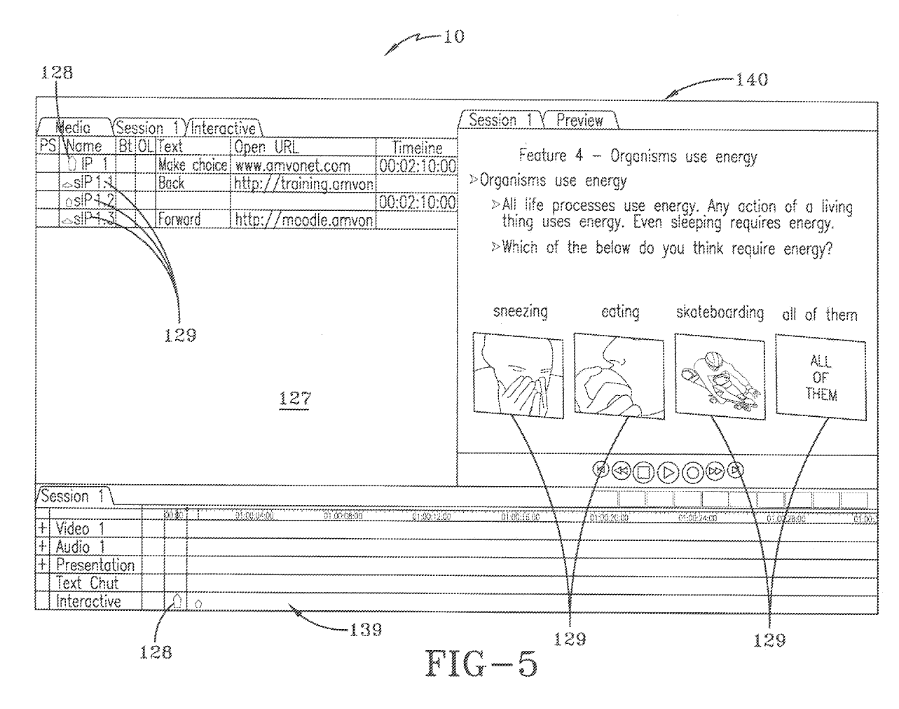

With reference now to FIG. 5, a user interface 140 including an editing suite and mixer 127 of the method for creating interactive points 10 of the present invention is shown. Editing suite and mixer 127 are used to create the interactive points shown in FIGS. 2-4. A primary interactive point is represented by icon 128, and corresponding sub-interactive points 129 correspond to the interactive points shown in FIGS. 2-4, that is, multimedia overlays, computer generated buttons with or without text, URL's, files on demand, assessments, and the like. An electronic timeline 139 for the original source interactive multimedia content is also displayed. With user interface 140, a user is able to select a specific interactive point, for further creation or editing.

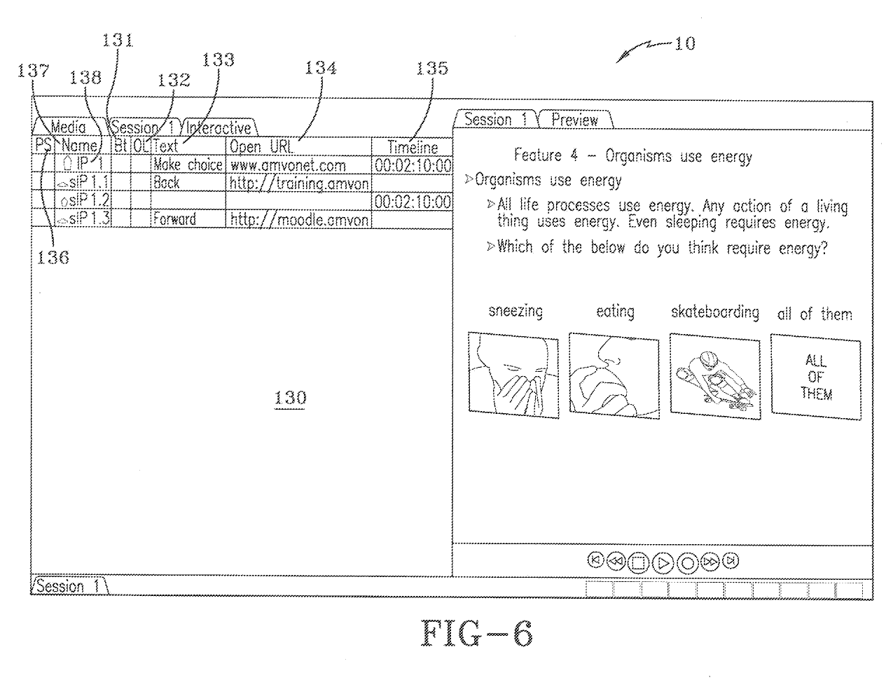

With additional reference now to FIG. 6, when a user selects an interactive point, the user then enters a programming interactive point creation table 130. Creation table 130 includes command cells and functions that program selected command cells. These command cells and functions include the creation and, programming of computer-generated buttons, reflected by icon Bt 131; the creation and programming of multimedia overlays, reflected by icon OL 132; the creation and programming of any text, or optionally no text, for computer-generated buttons and multimedia overlays, reflected by icon Text 133; for creation and programming of an interactive point that links to a URL automatically or on demand, reflected by icon Open URL 134; and for creation of an interactive point that links to a frame or point of electronic timeline 139 (FIG. 5) of the interactive multimedia content created inside of server 105, reflected by icon Timeline 135.

Additional command cells and functions include a pause session command cell, reflected icon “PS” 136; an interactive point mark and interactive point name command cell, reflected by icon “Name” 137; and a sub-interactive point mark and sub-interactive point name command cell, reflected by an icon “IP” 138.

When an interactive point is created by a user in creation table 130 or by an administrator of server 105 (FIG. 1), original source interactive multimedia content timeline 139 (FIG. 5) preferably includes certain default values to enhance the user's learning experience. By way of example, these default values include pausing of the playback of the original source interactive multimedia content, the duration of time associated with a particular point along, timeline 139, and any attributes for a computer-generated button. These and other values can be changed by the user when the user selects the desired or appropriate cell, and edits or manipulates the corresponding settings for that cell, as known to those skilled in the art. The cells in command table 130, as well as the icons displayed in the command table and the separate source interactive multimedia content thereof, are able to be edited by a user in order to change the values or directions for the interactive multimedia content.

In this manner, method for creating interactive points 10 of the present invention enables a user to make, edit and mix different types of digital multimedia and electronic information, which results in interactive multimedia content formed from original source interactive multimedia content and separate source interactive multimedia content with interactive assessment or a digital interactive book of educational or entertainment value.

The method for creating interactive points 10 of the present invention provides steps and system for the creation, mixing, recording, editing, storing and delivery of interactive educational content. A graphical interface enables the creation, recording, editing and mixing of any type of multimedia content that is created inside of the application, with any separate source interactive multimedia content residing on the user's computer or on the World Wide Web or elsewhere. The graphical interface also enables the creation of interactive points, which provide a connection between one part of the original source interactive multimedia content to any other part of the separate source interactive multimedia content, or to a new source of interactive multimedia content. Interactive points may be imbedded into any part of an electronic timeline of the multimedia content, or installed on top of any viewable part of the interactive multimedia content that is displayed for the user. The interactive points may be represented by any visual object. Interaction of the user with the interactive points enables navigation of the flow of delivery of the interactive multimedia content to any part of the overall multimedia interactive content or to an interactive assessment.

It is to be understood that the method for creating interactive points of the present invention may be altered or rearranged, or certain steps or components omitted or added, without affecting the overall concept or operation of the invention. It is also to be understood that a user or a third-party may upload the original interactive multimedia content without affecting the concept or operation of the invention. It is to be further understood that the names for different icons and buttons may be different names, icons or representations without affecting the concept or operation of the invention. It is to be understood that the interactive multimedia content may be stored on the server, on the third-party server, and on the user device or any combination thereof without affecting the concept or operation of the invention.

Accordingly, the method for creating interactive points provides an effective channel to educate users and allow users to interact with the interactive multimedia content and which achieves all the enumerated objectives, provides for eliminating difficulties encountered with the prior art and solves problems and obtains new results in the art.

In the foregoing description, certain terms have been used for brevity, clarity and understanding, but no unnecessary limitations are to be implied therefrom beyond the requirements of the prior art, because such terms are used for descriptive purposes and are intended, to be broadly construed. Moreover, the present invention has been described with reference to an exemplary embodiment. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the method for creating interactive points is arranged and used, the characteristics of the arrangement, and the advantageous, new and useful results obtained; the new and useful elements, arrangements, parts and combinations are set forth in the appended claims.

What is claimed is:

1. A method of creating interactive points to provide an interactive educational content based on at least one of live and prerecorded digital multimedia content, the method comprising the steps of:
recording an original source interactive multimedia content to a server;
receiving a separate source interactive multimedia content created by at least one third-party;
creating at least one interactive point within said original source interactive multimedia content including a reference to a uniform resource locator (“URL”) stored in said server, linking said at least one interactive point to said separate source interactive multimedia content;
altering said original source interactive multimedia content to include said separate source interactive multimedia content when said at least one interactive point is selected;
transmitting said altered original source interactive multimedia content corresponding to said at least one selected interactive point to a user device for user interaction;
receiving an indication from said user device corresponding to said user interaction; and
determining a response to said received indication wherein said response corresponds to at least one of continuing user interaction, assessing the received indication, and switching to a new source interactive multimedia content.

2. The method of claim 1, wherein said at least one interactive point corresponds to a timeline frame number wherein said timeline frame number automatically redirects said user from interaction with said original source interactive multimedia content to said separate source interactive multimedia content.

3. The method of claim 1, wherein said selection of the interactive point is targeting said separate source interactive multimedia content created by said user or said third-party inside of a third-party application and residing on said user device referenced by a location on a storage media of said user device.

4. The method of claim 1, wherein said selection of said at least one interactive point is targeting said original source of interactive multimedia content on at least one of a LAN, a World Wide Web or said URL.

5. The method of claim 1, wherein selection of said at least one interactive point is targeting an interactive assessment of user interaction with said at least one of original source interactive multimedia content, said separate source interactive multimedia content, and said new source interactive multimedia content that transmits the at least one of original source interactive multimedia content, the separate source interactive multimedia content, and the new source interactive multimedia content from an original location onto said user device.

6. The method of claim 1, wherein said determined response in assessing said received indication switches to said at least one of original source interactive multimedia content, said separate source interactive multimedia content, and said new source interactive multimedia content in accordance with a result of an interactive evaluation of the received indication.

7. The method of claim comprising displaying said altered original source interactive multimedia content on said user device for continued interaction with said at least one of said original source interactive multimedia content, said separate source interactive multimedia content and said new source interactive multimedia content within a window of a browser on said user device or in a separate widow.

8. The method of claim 1, wherein first interactive multimedia content is associated with a timeline range of at least one of said original source interactive multimedia content, said separate source interactive multimedia content and said new source interactive multimedia content which said first interactive multimedia content is displayed.

9. A non-transitory computer-readable storage medium with an executable program stored thereon for providing an interactive multimedia content for a user to create or interact with interactive points corresponding to an interactive multimedia content, wherein said program instructs a microprocessor to perform the following steps:
storing said interactive multimedia content in an interactive multimedia content server database, wherein said interactive multimedia content comprises at least one of an original source interactive multimedia content and a separate source interactive multimedia content created by a third-party;
storing at least one interactive point in said multimedia content server database in association with said at least one of said original source interactive multimedia content and said separate source interactive multimedia content, wherein said at least one interactive point is reached by a play head over a timeline;
determining, a response based upon a predetermined frame number corresponding to said play head, whether to at least one of altering said original source interactive multimedia content, providing said user with a choice of switching to said separate source interactive multimedia content and continuing to interact with said interactive multimedia content; and
transmitting said determined response to a user device.

10. The non-transitory computer readable storage medium according to claim 9 comprising, wherein once said play head reaches said predetermined frame number, dividing said timeline into at least one frame, linking said at least one interactive point to a timeline frame number, automatically redirecting said user from interaction with said interactive multimedia content to at least one of an additional part of said original source interactive multimedia content and said separate source interactive multimedia content as programmed by the user in reference to said timeline frame number located along said timeline of the interactive multimedia content.

11. A non-transitory computer readable storage medium according to claim 9 comprising, wherein said interactive point is targeting at least one of said original source interactive multimedia content and said separate source interactive multimedia content previously created by at least one of said user and a third-party inside of a third-party application and residing on said user device referenced by a location on a storage media of the user device.

12. A non-transitory computer readable storage medium according to claim 9 comprising, wherein said interactive point is targeting a source of interactive multimedia content residing on at least one of a Land Area Network, World Wide Web, and Uniform Resource Locator.

13. The non-transitory computer readable storage medium according to claim 9 comprising, wherein said interactive point is targeting an interactive assessment of user interaction with said interactive multimedia content that transmits at least one of said original source interactive multimedia content and said separate source interactive multimedia content to said user device referenced by an address in a root directory.

14. The non-transitory computer readable storage medium according to claim 9 comprising, wherein the interactive multimedia content to appear on the user device for at least one of continued interaction of the user with the interactive multimedia content or interactive assessment of the user with the interactive multimedia content that appears inside of a browser window or in a separate window.

15. A computer system for providing a creation and a mix of educational interactive multimedia content based on different types multimedia materials with automatic assessment, said computer system comprising:
a server application with a database and an interactive point database storing an interactive multimedia content and an interactive point corresponding to at least one of original interactive multimedia content, separate source interactive multimedia content and a uniform resource locator (“URL”), wherein said interactive point is reached by a play head of said computer system, causing playback of said original interactive multimedia content to be altered by overlapping said original interactive multimedia content with a new source interactive multimedia content that opens in a separate window and at least one or opening on top of a browser, inside of a presentational window of said browser, and paused for said user to make a selection, said selection appearing alone or with at least one of a button and selected object highlighted, and installed on top or inside of the original interactive multimedia content on a user device in a form of said button with at least one of a key with text, picture, animation and any other visual art object found in said presentational window of said browser and selecting at least one of said key and said visual art object to send a request to said server application to request new source interactive multimedia content and display the new source interactive multimedia content on said user device for interaction with the new source interactive multimedia content in conjunction with a selection of the interactive point from the user device.

16. The computer system of claim 15, wherein said play head of a browser player reaches a predetermined frame number, said interactive point corresponding to a timeline frame number, automatically redirecting said user from at least one of observation and interaction with original interactive multimedia content to new source interactive multimedia content as programmed by the user in reference to said timeline frame number located along a length of a timeline of original interactive multimedia content.

17. The computer system of claim 15, wherein said interactive point is targeting a source of interactive multimedia content residing, on at least one of said user device, a land area network (“LAN”), World Wide Web, and said URL.

18. The computer system of claim 15, wherein said interactive point transmits to said user device an alert that the interactive point is reached by said play head of said system, altering playback of said original interactive multimedia content by overlapping the original interactive multimedia content with said new source interactive multimedia content, which opens at least one of said separate window on said browser of said user device, inside of said presentational window of the browser, and playback of original interactive multimedia content is paused for said user to select interaction with at least one of the original interactive multimedia content, the new source interactive multimedia content or said URL.

19. The computer system of claim 15, wherein said interactive point corresponds to a number of a frame residing on a timeline of said original interactive multimedia content of said server, during which said interactive point is represented by “button(s)” or “selected object(s)” are displayed.
